(19) United States
(12) Patent Application Publication
(10) Pub. No.: US 2004/0021769 A1
(43) Pub. Date: Feb. 5, 2004

(54) Method for detecting artifacts for use in a film scanner

(75) Inventors: Scott McCloskey, Rochester, NY (US); Keith A. Jacoby, Rochester, NY (US); Robert W. Kulpinski, Penfield, NY (US); Douglas W. Christoffel, Rochester, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/209,428

(22) Filed: Jul. 31, 2002

(51) Int. Cl. H04N 5/253; H04N 7/18

(52) U.S. Cl. 348/96; 348/126

(57) ABSTRACT

A method for detecting artifacts produced during film scanning in a scanning device, the method includes the steps of (a) providing film having a plurality of frames with an area of substantially constant density; (b) scanning the area of substantially constant density by the scanning device; (c) generating a profile consisting of the average of substantially all pixels at substantially the same location in the area of substantially constant density; and (d) detecting an artifact based on comparing the profile to a first threshold.

### FIELD OF THE INVENTION

The invention relates generally to the field of scanners and, more particularly, to such scanners which detect artifacts due to contaminants in the scanner.

### BACKGROUND OF THE INVENTION

Presently known scanners scan photographic film containing captured images for forming digital representation of the images. Such scanners may contain contaminants, such as dust and the like, which causes artifacts to be present in the digital representation. Currently known and utilized scanners include filters for assisting in analyzing the digital image data for such artifacts. One such prior art scanner is disclosed in U.S. Pat. No. 5,065,444.

Although satisfactory, the presently known and utilized scanners can be improved. One such needed improvement is a scanner which utilizes portions of the film not containing images since such portions are not subject to substantially wide ranges of intensity, and consequently, are more consistent for purposes of analysis.

### SUMMARY OF THE INVENTION

The present invention is directed to overcoming one or more of the problems set forth above. Briefly summarized, according to one aspect of the present invention, the invention resides in a method for detecting artifacts produced during film scanning in a scanning device, the method includes the steps of providing film having a plurality of frames with an area of substantially constant density; scanning the area of substantially constant density by the scanning device; generating a profile consisting of the average of substantially all pixels at substantially the same location in the area of substantially constant density; and detecting an artifact based on comparing the profile to a first threshold.

These and other aspects, objects, features and advantages of the present invention will be more clearly understood and appreciated from a review of the following detailed description of the preferred embodiments and appended claims, and by reference to the accompanying drawings.

### ADVANTAGEOUS EFFECT OF THE INVENTION

The present invention includes the advantage of analyzing non-image portions of the digital data such portions contain consistent, pre-known data which is better suited for analysis.

### BRIEF DESCRIPTION OF THE DRAWINGS

FIG. 1 is a overview of the scanner of the present invention;

FIG. 2 is an illustration of typical film showing typical lines of pixels as used herein;

FIG. 3 is a profile produced by the scanner of the present invention used for detecting artifacts; and

FIG. 4 is a filtered version of FIG. 3 also used for detecting artifacts.

### DETAILED DESCRIPTION OF THE INVENTION

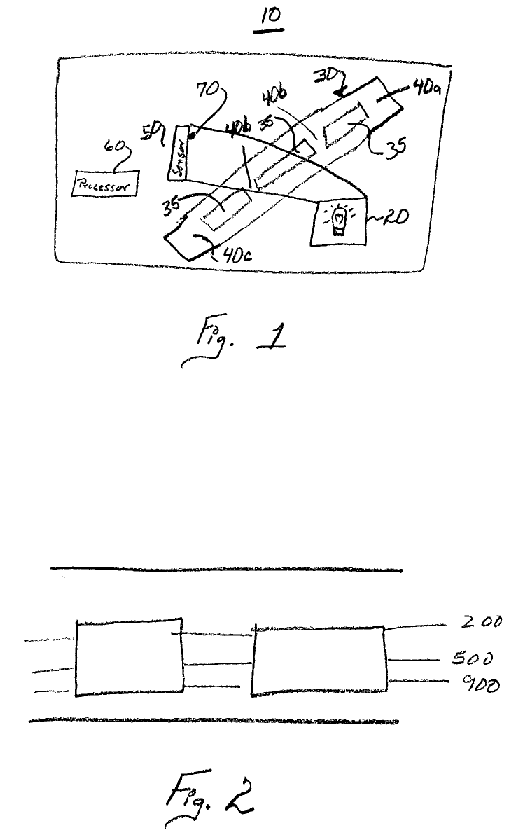

Referring to FIG. 1, there is shown a scanning device 10 having an illumination source 20 for illuminating the film 30 having a plurality of frames 35 that is passed therethrough under the illumination source 20. The film includes a plurality of areas of substantially constant optical density 40. The constant density areas may be, for example, the leader 40a, the gaps 40b between frames, or the trailer portion 40c. It facilitates understanding to note that areas of substantially constant density are areas through which light passes at a constant intensity. For example, the frames containing images are not areas of constant density as will be apparent, and substantially all other portions of the film not having a captured image may be areas of constant density.

A linear sensor 50 receives the light passed through the film 30 for forming a digital representation of the captured image. A processor 60 is positioned in the scanning device 10 for performing calculations and the like, as is well known in the art.

For clarity of understanding, a typical contaminant 70 is shown disposed on the sensor. This contaminant 70 will cause streaking in the scanned data received by the sensor 50. Although the contaminant 70 is shown on the sensor 50, the contaminant 70 may be in any of numerous places in the scanning device 10. For example, the contaminant 70 may be on the illumination source 20 or anywhere in the optical path between the illumination source 20 and the sensor 50.

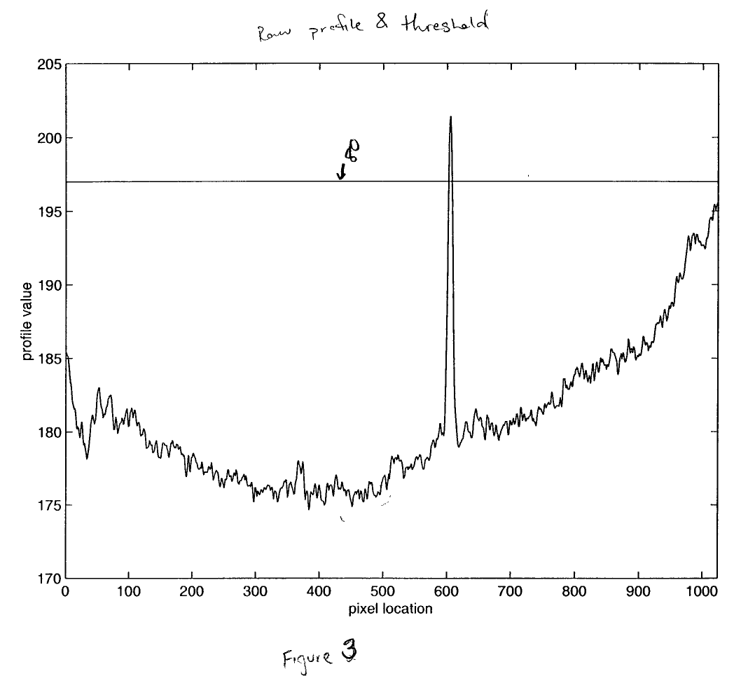

Referring to FIG. 2, it facilitates understanding to note that the scanned data from the film that is produced by the sensor includes a plurality of lines of pixel locations. For example, in FIG. 2, the plurality of lines of pixel locations are shown as pixel line locations 200, 500 and 900. The lines of pixel locations are based on the resolution of the scanning device and will vary from device to device; the values 200, 500 and 900 being only typical line locations.

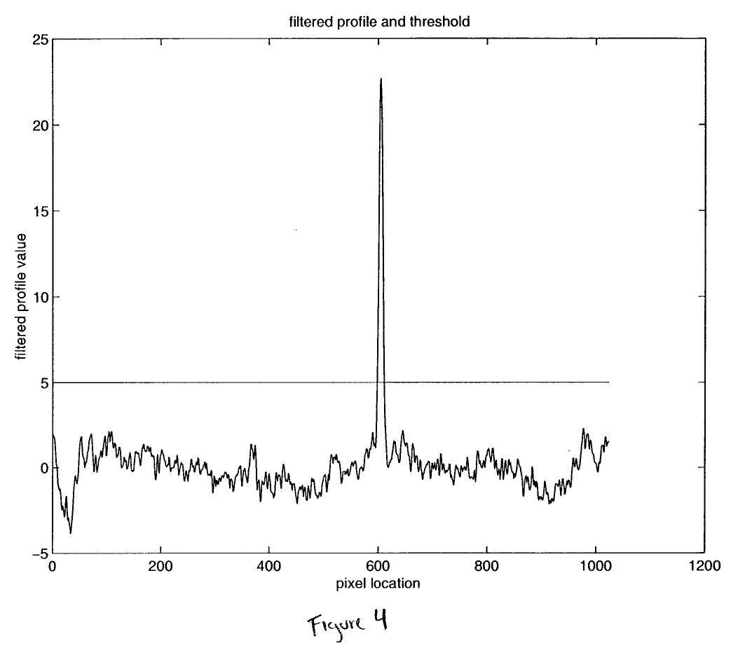

Referring to FIG. 3, there is shown a profile generated by the processor 60 by capturing a portion of a line of pixels in at least one area of constant optical density 40. The profile includes the average pixel value for the pixels in at least a portion of a pixel line location. For example, line location 200 includes a plurality of pixels, and the average pixel value is generated from some portion of the pixel values within the line 200. As may be apparent, the profile includes the aggregate in sequential order of the averages along each pixel location line.

A typical contaminant 70 produces an artifact that is represented by a spike in the profile. The representation of the artifact (the spike in FIG. 3) may be of various shapes or polarities depending on the contaminant 70. A predetermined threshold 80 is used to identify representations of artifacts in the scanned data. The threshold is based on the largest expected deviation from the average value of the profile. This threshold value may be produced by those skilled in the art based on particular scanner 10 as obtained from correlation studies.

Referring to FIG. 4, there is shown a filtered version of FIG. 3 also generated by passing the profile of FIG. 3 through a filter. In this regard, the values of the profile are filtered by a high pass filter. Such high pass filters are well known in the art and will not be discussed herein. This filtering produces a profile, which eliminates extreme low frequency variation in the profile that may interfere with thresholding. This permits the threshold to be set so that it is closer to the variation due to scanner noise. This threshold is still high enough so as not to allow the scanner noise to surpass the threshold.

The invention has been described with reference to a preferred embodiment. However, it will be appreciated that variations and modifications can be effected by a person of ordinary skill in the art without departing from the scope of the invention.

Parts List

10 scanning device

20 illumination source

30 film

35 captured images/frames

40 constant optical density portions

40a leader

40b gaps

40c trailer portion

50 linear sensor

60 processor

70 contaminant

80 threshold

200 pixel line locations

500 pixel line locations

900 pixel line locations

What is claimed is:

1. A method for detecting artifacts produced during film scanning in a scanning device, the method comprising the steps of:
(a) providing film having a plurality of frames with an area of substantially constant density;
(b) scanning the area of substantially constant density by the scanning device;
(c) generating a profile consisting of the average of substantially all pixels at substantially the same location in the area of substantially constant density; and
(d) detecting an artifact based on comparing the profile to a first threshold.

2. The method as in claim 1, wherein step (d) includes detecting the artifact based in comparing a value derived from the profile to an area threshold.

3. The method as in claim 1 further comprising the step of filtering the profile to produce a subsequent profile that is subjected to the thresholding.

4. The method as in claim 1, wherein step (d) includes producing the threshold based on data obtained from correlation studies.

5. The method as in claim 2 further comprising the step of filtering the profile to produce a subsequent profile that is subjected to the area thresholding.

6. The method as in claim 1, wherein step (b) includes scanning either individually or any combination of a gap between at least two of the frames, a leader portion or a trailer portion.

7. A scanner for detecting artifacts produced during scanning of film, the scanner comprises:
(a) a receiving portion for receiving film having a plurality of frames with an area of substantially constant density;
(b) a scanning portion for scanning the area of substantially constant density by the scanning device; and
(c) a processor for generating a profile consisting of the average of substantially all pixels at substantially the same location in the area of substantially constant density, and for detecting an artifact based on comparing the profile to a first threshold.

8. The scanner as in claim 7, wherein the processor detects the artifact based on comparing a value derived from the profile to an area threshold.

9. The scanner as in claim 7 further comprising a filter for filtering the profile to produce a subsequent profile that is subjected to the thresholding.

10. The scanner as in claim 7, wherein the processor produces the threshold based on data obtained from correlation studies.

11. The scanner as in claim 8 further comprising a filter for filtering the profile to produce a subsequent profile that is subjected to the area thresholding.

12. The scanner as in claim 7, wherein the scanner portion includes scanning either individually or any combination of a gap between at least two of the frames, a leader portion or a trailer portion.
